(19) United States
(12) Patent Application Publication
(10) Pub. No.: US 2008/0073449 A1
(43) Pub. Date: Mar. 27, 2008

(54) Rotating relaxer shower head

(76) Inventors: John L. Haynes, Minneapolis, MN (US); Mercedes Haynes, Minneapolis, MN (US)

Correspondence Address: Galasso & Associates, LP, P.O. Box 26503, Austin, TX, 78755-0503, US

(21) Appl. No.: 11/526,466

(22) Filed: Sep. 25, 2006

(51) Int. Cl. B05B 1/14

(52) U.S. Cl. 239/556; 239/566

(57) ABSTRACT

Rotating Relaxer Shower Head has a housing with multiple heads that rotate and a standard connection for use with piping in a bathroom. A user simply turns the shower on in the ordinary manner and positions his body underneath the housing with the multiple showerheads. Water enters the housing through the standard connection and spins the multiple showerheads, causing a rotating stream of water to be emitted through the plurality of holes in the heads. The water then contacts the user in a rhythmic, rotating manner that helps relax and cleanse a user.

### CROSS REFERENCE TO RELATED APPLICATIONS

This Non-Provisional Patent Application does not claim priority to any U.S. provisional application or any foreign patent applications.

### FIELD OF THE DISCLOSURE

The disclosures made herein relate generally to the bathroom accessory industry. The invention discussed herein is in the general classification of shower accessory devices.

### BACKGROUND

Most people engage in a variety of personal hygiene routines everyday. These include brushing and flossing of one's teeth, cutting one's nails, regular bathing, and washing of one's clothes. Many also routinely wash their hair using a standard showerhead device that permits water to travel through a standard connection into a housing and then through a plurality of holes in the showerhead.

Showering provides a variety of benefits. Skin infections, lice and dandruff in the hair and other potential health dangers can be mitigated or prevented through daily showering. In addition to these obvious health benefits, showering can provide a relaxing and soothing atmosphere for an individual. A warm shower can provide relief from a stressful or active day. The water pressure and warm water can relieve a user's sore muscles and raise the user's core body temperature.

A variety of showerheads have been designed to enhance the showering experience. High-pressure showerheads cause the streams of water coming from the housing to massage a user's back or other areas through a more intense spray. These showerheads can create too hard of a water stream that a user may find uncomfortable. In addition, these showerheads still only contact a user in one location and can create larger water bills because more water flows through them in any designated period of time.

Adjustable showerheads allow a user to modify the intensity and number of streams of water coming from the showerhead. However, these types of showerheads still only contact a user in approximately one central location. A user must constantly move around in the shower or adjust the showerhead to contact different parts of his body.

For the energy efficient user, a low stream showerhead can be utilized in a shower to lessen the flow of water and lower the water bill. However, these showerheads tend not to provide the massaging and soothing action of standard or other types of showerheads. In addition, these types of showerheads are less effective in rinsing away soap or shampoo from a user's body.

Hence, there is a need in the art for an easy to use and install, effective, inexpensive and rotating showering device with multiple heads that will massage and cleanse a user in multiple locations on the user's body.

### SUMMARY OF THE DISCLOSURE

Rotating Relaxer Shower Head consists of at least some of the following: a housing with multiple heads that rotate and a standard connection for use with piping in the shower area of a bathroom. A user simply turns the shower on in the ordinary manner and positions his body underneath the housing with the multiple showerheads. Water enters the housing through the standard connection and spins the multiple showerheads, causing a rotating stream of water to be emitted through the plurality of holes in the showerheads. The water then contacts the user in a rhythmic, rotating manner that helps relax and cleanse a user.

The principal object of this invention is to provide a rotating showerhead device capable of massaging and cleansing a user in multiple locations on the body of the user.

Another object of this invention is to provide an affordable alternative showerhead device.

Another object of this invention is to provide an easy to use and install alternative showerhead device.

Yet another object of this invention is to provide a showerhead device that is cost efficient yet effective.

### BRIEF DESCRIPTION OF THE DRAWINGS

FIG. 1 depicts a perspective view of the preferred embodiment of the invention.

FIG. 2 depicts a top view of the preferred embodiment of the invention.

FIG. 3 depicts a frontal view of the preferred embodiment of the invention.

### DETAILED DESCRIPTION OF THE DRAWINGS

The preferred embodiment of Rotating Relaxer Shower Head is comprised of at least some of the following: a housing with multiple heads that rotate and a standard connection for use with piping in a bathroom. The Rotating Relaxer Shower Head also has a plurality of openings in each head.

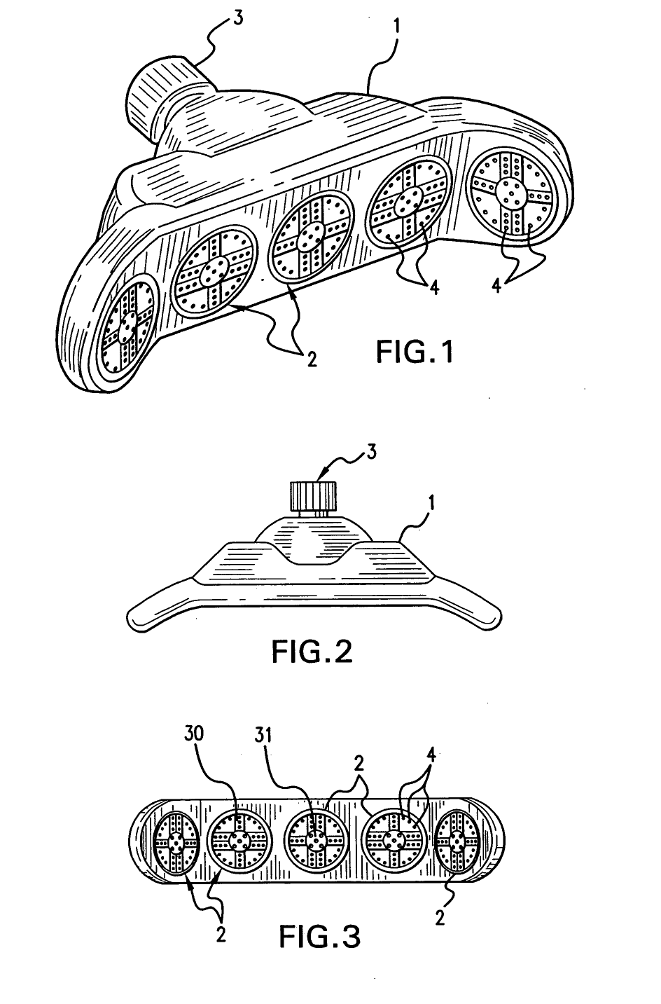

In the preferred embodiment of the invention, shown in FIG. 1, a housing 1 made of metal has five heads 2 spaced along one side. The housing 1 has a curved shape to allow the heads 2 to surround a user when the device is in use. Three of the five heads 2 are located in a straight line on one side of the housing 1. Two additional heads are located at angles to the straight line of heads on opposite ends of the housing 1. A standard connection 3 is located on the side of the housing 1 opposite the five heads 2. The standard connection 3 can be easily attached to the piping of an ordinary bathroom shower. The standard connection 3 permits water to enter the housing 1 when a user turns on the water in an ordinary manner. The five heads 2 are made of plastic and have a plurality of holes 4. The five heads 2 are circular in shape and are placed on the housing 1 in a manner to permit them to rotate while they are in use.

Within the housing, blades (not pictured) are attached to the five heads 2. These blades are oriented at appropriate angles to permit the blades to rotate in either the counterclockwise or clockwise direction. In the preferred embodiment, three of the five heads 2 will have blades that rotate in the clockwise direction and two of the five heads 2 will have blades that rotate in the counterclockwise direction. Obviously, any number of the five heads 2 could be designed to spin in any direction.

FIG. 2 depicts a top view of the preferred embodiment of the invention. This angle shows how the standard connection 3 will be attached in a shower. The curve of the housing 1 is also shown in greater detail. As discussed previously, this curved design of the housing 1 permits multiple areas of a user to be contacted by the various water streams emitted from the heads. The shoulders, back and neck of a user can all be simultaneously contacted with water streams from the five heads in this preferred embodiment of the invention.

FIG. 3 shows the front view of the preferred embodiment of the invention. In this view, the five heads 2 and the plurality of holes 4 can be seen in greater detail. Each of the five heads 2 have a cross pattern 30 with a center circle 31. The plurality of holes 4 is concentrated around the periphery of the five heads 2 and within the cross pattern 30 and center circle 31 of each of the five heads 2.

In order to use Rotating Relaxer Shower Head, a user simply turns the shower on in the ordinary manner and positions his body underneath the housing with the multiple showerheads. Water enters the housing through the standard connection. The water then contacts the blades within the housing, causing the blades to spin the multiple showerheads in different directions. The water entering the housing is then emitted through the plurality of holes in the various heads. The water finally contacts the user in a rhythmic, rotating manner that helps relax and cleanse a user without requiring the user to constantly move his or her body into the water stream.

The components of Rotating Relaxer Shower Head may vary widely but will likely include plastic, metal and other components. The metals would ideally be selected from available steel or alloys of steel and aluminum. The production process related to the use of these metals insures that the metal is non-corrosive, durable and strong. The selected metal should have high impact strength and be capable of accepting and retaining coloring materials for an extended length of time.

The plastic used in the production will ideally be selected for durability and longevity. Thermoplastics are commonly used in the manufacturing of components similar to those used in this invention. Polyethylene, polypropylene, and other similar thermoplastic materials would be among those with the necessary traits. Members of this family are recognized universally as being versatile and of high quality.

The plastic components of Rotating Relaxer Shower Head can also be formed with the use of plastic molding techniques, such as injection molding or blow molding. Injection molding requires melted plastic to be forcefully injected into relatively cool molds. As the plastic begins to harden, it takes on the shape of the mold cavity. This technique is ideal for the mass production of products. Alternatively, blow molding, a form of extrusion, could be utilized. Blow molding involves a molten tube being pushed into a mold. Compressed air then forces the molten tube against the cold walls of the mold.

It should be obvious that the housing and other components of the present invention can be of various shapes and sizes. The preferred embodiment of the housing is approximately fifteen inches in width and two and a half inches in height. Each head would be approximately two inches in diameter in the preferred embodiment of the invention.

It should also be obvious that the components of the invention can be made of different types of plastics or other suitable materials and can be of any color. For example, the housing could be made of plastic instead of metal. It should further be obvious that although five heads are used in the preferred embodiment of the invention, any number of heads could be used and still be within the spirit of this invention. In addition, while blades and the ordinary flow of water through the housing are utilized for spinning the heads in the preferred embodiment, it should be obvious that a variety of methods for spinning the heads are available and within the scope of this invention.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A bathroom accessory comprising:
(a) a housing with a plurality of rotating heads spaced along the perimeter of the housing;
(b) a plurality of holes through the plurality of rotating heads; and
(c) a connection on one side of the housing.

2. The bathroom accessory of claim 1 wherein the housing is curved.

3. The bathroom accessory of claim 1 wherein the housing is made of metal.

4. The bathroom accessory of claim 1 wherein the housing is made of plastic.

5. The bathroom accessory of claim 1 wherein each of the plurality of rotating heads is made of plastic.

6. The bathroom accessory of claim 1 wherein each of the plurality of rotating heads is made of metal.

7. The bathroom accessory of claim 1 wherein each of the plurality of rotating heads is circular.

8. The bathroom accessory of claim 1 wherein each of the plurality of rotating heads is attached to a plurality of blades within the housing.

9. The bathroom accessory of claim 1 wherein each of the plurality of rotating heads has a cross pattern and a center circle.

10. The bathroom accessory of claim 9 wherein the plurality of holes is located along the periphery and within the cross pattern and the center circle of each of the plurality of rotating heads.

11. A bathroom accessory comprising:
(a) a housing with a rotating head on one side of the housing;
(b) a plurality of holes through the rotating head; and
(c) a connection on the side of the housing opposite the rotating head.

12. A bathroom accessory comprising:
(a) a curved metal housing with a first rotating plastic head, a second rotating plastic head, a third rotating plastic head, a fourth rotating plastic head and a fifth rotating plastic head spaced along the front of the curved metal housing;
(b) a first plurality of holes through the first rotating plastic head, a second plurality of holes through the second rotating plastic head, a third plurality of holes through the third rotating plastic head, a fourth plurality of holes through the fourth rotating plastic head and a fifth plurality of holes through the fifth rotating plastic head;
(c) a first set of blades attached to the first rotating plastic head, a second set of blades attached to the second rotating plastic head, a third set of blades attached to the third rotating plastic head, a fourth set of blades attached to the fourth rotating plastic head, and a fifth set of blades attached to the fifth rotating plastic head; and
(d) a standard connection on the side of the curved metal housing opposite the first rotating plastic head, the second rotating plastic head, the third rotating plastic head, the fourth rotating plastic head, and the fifth rotating plastic head.
